(19) United States
(12) Patent Application Publication
(10) Pub. No.: US 2023/0191653 A1
(43) Pub. Date: Jun. 22, 2023

(54) METHOD FOR THE LAYER-BY-LAYER PRODUCTION OF A CURED THREE-DIMENSIONAL SHAPED BODY, SHAPED BODY OBTAINABLE BY THE METHOD, AND USE THEREOF

(71) Applicant: ASK CHEMICALS GMBH, Hilden (DE)

(72) Inventors: Dennis BARTELS, Dorsten (DE); Dominik POLSAKIEWICZ, Bonn (DE)

(21) Appl. No.: 17/924,866

(22) PCT Filed: Jun. 14, 2021
(86) PCT No.: PCT/EP2021/065939

§ 371 Date: Nov. 11, 2022

(30) Foreign Application Priority Data
Jun. 15, 2020 (DE) 10 2020 003 562.0

(51) Int. Cl. B28B 1/00; B22C 1/22; B22C 9/10; B22C 9/06

(52) U.S. Cl. CPC B28B 1/001; B22C 1/224; B22C 9/06; B22C 9/10; B33Y 70/10

(57) ABSTRACT

The present invention relates to a method for the layer-by-layer production of a cured three- dimensional shaped body, wherein the method comprises at least: (i) providing a binder comprising at least the following components: a) monomeric furfuryl alcohol and optionally a resin component comprising at least a furan resin, wherein about 60% by weight to 100% by weight of monomeric furfuryl alcohol, based on the sum of monomeric furfuryl alcohol and resin component are present in the binder, and b) a hardener component selected from methanesulfonic acid, benzenesulfonic acid, and mixtures thereof, (ii) providing a layer of a refractory molding material to provide a molding material layer, (iii) selectively applying a component a) or b) of the binder separately from the refractory molding material to at least a part of the molding material layer, (iv) applying the other component of the binder separately from the component mentioned in step (iii), wherein step (iv) can be carried out before or after step (iii), or step (iv) can be combined with step (ii), and (v) optionally repeating steps (ii), (iii), and (iv) once or several times. Shaped bodies obtainable thereby as well as their use are disclosed as well.

The present invention relates to a method for the layer-by-layer production of a cured three-dimensional shaped body. The shaped bodies produced in this manner are suitable, inter alia, as casting cores and molds for metal casting.

Various methods are known for the layer-by-layer production of three-dimensional shaped bodies. By means of these methods, bodies with even the most complicated geometries can be produced directly by 3D printing layer-by-layer from the CAD data and without molding tools. This is not possible with conventional methods requiring molds.

WO 2001/068336 discloses various binders for layer-by-layer production. Inter alia, the use of a furan resin, which is not described in further detail, with at least 50% furfuryl alcohol and about 4% ethylene glycol is also cited as a binder component. The resin component of the binder is sprayed layer-by-layer over the entire working surface of a loose molding material and is then cured also layer-by-layer, but with the selective application of a hardener such as an organic acid. Toluenesulfonic acid is disclosed as organic acid.

WO 01/72502 describes a variation of this method, wherein a liquid binder material, inter alia also a furan resin, which is not described in further detail, as well as a liquid hardener such as toluenesulfonic acid are applied selectively, one after the other in the sequence of resin component and then hardener, to the sections to be cured.

According to WO 03/103932, the resin component of the binder is no longer applied layer-by-layer by means of a printhead but is mixed directly with the molding material and applied layer-by-layer with the molding material. This mixture of resin component and molding material is then cured by a selective application of sulfurous acid as hardener.

Another method for the layer-by-layer production of cured three-dimensional shaped bodies is disclosed in WO 2018/224093. In this document, a resin component which contains a furan resin as the reaction product of at least an aldehyde compound with furfuryl alcohol, and optionally nitrogen containing compounds and/or phenol compounds, is used, wherein the nitrogen content of the resin component is less than 5% by weight and wherein the resin component comprises more than 5% by weight and less than 50% by weight monomeric furfuryl alcohol, based on the resin component.

In WO 2004/110719, the sequence of addition is reversed. First, the molding material is premixed with a hardener, and then the resin component is selectively applied layer-by-layer. Acids, amines, and esters are described as hardeners. The hardeners are not described in any more detail.

In DE 10 2014 106 178, a method for the layer-by-layer production of bodies is described in which a molding material is hardened in layers by means of a resol resin and an ester.

In particular, the acid/furan resin system according to WO 2004/110719 and the ester/resol resin system according to DE 10 2014 106 178 have been somewhat accepted in practice for the layer-by-layer production of shaped bodies and are used in the development of new cast parts and in the production of individual parts or small series when a conventional production with molding tools would be too complex and expensive, or only feasible with a complicated core package.

The acid/furan resin system has the disadvantage that shaped bodies produced according to this method first have to be freed from an adhering and non-printed mixture of the molding material and acid or resin component in a complicated process. Individuals who perform this task are exposed to solvent and binder vapors in addition to dusts.

### OBJECT OF THE INVENTION

It is therefore the object of the present invention to provide a method for the layer-by-layer production of a cured three-dimensional shaped body wherein the tendency of unbonded mixture to adhere to the resulting shaped bodies is minimized. Thus, the effort required to remove the unbonded sand from bonded regions is minimized. In addition to the resulting time savings, the staffs exposure to solvent and/or binder vapors is minimized as well. It is another object of the present invention to provide a method for producing three-dimensional shaped bodies with a high degree of bending strength.

The fact that the so-called job box of the 3D printer can be used with greater spatial efficiency is an additional advantage, i.e. the shaped bodies can be positioned closer to each other without the risk of the bodies adhering to each other. Furthermore, the non-printed molding material mixture can be reintroduced into the process more easily since areas which have already slightly reacted and cured are significantly reduced.

### SUMMARY OF THE INVENTION

It was surprisingly found that these objects could be achieved by a method for the layer-by-layer production of a cured three-dimensional shaped body, wherein the method comprises at least:
(i) providing a binder comprising at least the following components:
   a) monomeric furfuryl alcohol and optionally a resin component comprising at least a furan resin, wherein about 60% by weight to 100% by weight of monomeric furfuryl alcohol, based on the sum of monomeric furfuryl alcohol and resin component are present in the binder, and
   b) a hardener component selected from methanesulfonic acid, benzenesulfonic acid, and mixtures thereof,
(ii) providing a layer of a refractory molding material to provide a molding material layer,
(iii) selectively applying a component a) or b) of the binder separately from the refractory molding material to at least a part of the molding material layer,
(iv) applying the other component of the binder separately from the component mentioned in step (iii), wherein step (iv) can be carried out before or after step (iii), or step (iv) can be combined with step (ii), and
(v) optionally repeating steps (ii), (iii), and (iv) once or several times.

An especially advantageous embodiment of the method according to the present invention comprises at least the following steps:
α) Preparing a mixture of refractory molding material and the hardener component b),
β) providing a layer of the mixture of the refractory molding material and the hardener component b),
γ) selectively applying component a) to at least a part of the layer, and
δ) optionally repeating steps β) and _{γ}) once or several times.

Furthermore, the present invention relates to a shaped body obtainable by the method according to the invention. The shaped body can be used for metal casting, in particular iron, steel, copper, or aluminum casting.

### DESCRIPTION OF THE DRAWING

FIG. 1 shows the specimen geometry for the quantification of the adhesion occurring during the production process.

### DETAILED DESCRIPTION OF THE INVENTION

The method according to the present invention comprises at least
(i) providing a binder comprising at least the following components:
   a) monomeric furfuryl alcohol and optionally a resin component comprising at least a furan resin, wherein about 60% by weight to 100% by weight of monomeric furfuryl alcohol, based on the sum of monomeric furfuryl alcohol and resin component are present in the binder, and
   b) a hardener component selected from methanesulfonic acid, benzenesulfonic acid, and mixtures thereof,
(ii) providing a layer of a refractory molding material to provide a molding material layer,
(iii) selectively applying a component a) or b) of the binder separately from the refractory molding material to at least a part of the molding material layer,
(iv) applying the other component of the binder separately from the component mentioned in step (iii), wherein step (iv) can be carried out before or after step (iii), or step (iv) can be combined with step (ii), and
(v) optionally repeating steps (ii), (iii), and (iv) once or several times.

An especially advantageous embodiment of the method according to the present invention comprises at least the following steps:
α) Preparing a mixture of refractory molding material and the hardener component b),
β) providing a layer of the mixture of the refractory molding material and the hardener component b),
γ) selectively applying component a) to at least a part of the layer, and
δ) optionally repeating steps β) and _{γ}) once or several times.

### Refractory Molding Material

The refractory molding material is not particularly limited. Any particulate solids can be used as the refractory molding materials. Preferably, the refractory molding material is in a free-flowing state. Materials common and known for producing casting molds can be used in pure form or mixtures thereof as the refractory molding material. Suitable materials are for instance quartz sand, zirconium sand or chrome ore sand, olivine, vermiculite, bauxite, fireclay, and refractory molding materials that are produced artificially and/or are obtainable from synthetic materials (e.g. hollow microspheres). For cost reasons, quartz sand is particularly preferred. A refractory molding material is a material with a high melting point (melting temperature). Preferably, the melting point of the refractory molding material is at least about 600° C., more preferred at least about 900° C., especially preferred at least about 1200° C., and particularly preferred at least about 1500° C.

The average particle diameter of the refractory molding material is usually from about 30 µm to about 500 µm, preferably from about 40 µm to about 400 µm, and especially preferred from about 50 µm to about 250 µm. The particle size can be determined for example by sieving according to DIN ISO 3310.

### Molding Material Additives

In addition to the refractory molding material, the molding material layer can comprise additional solids. Within the framework of the present invention, they are referred to as molding material additives. They are usually particulate solids. The average particle diameter of the molding material additives is usually from about 30 µm to about 500 µm, preferably from about 40 µm to about 400 µm and especially preferred from about 50 µm to about 250 µm. The particle size can be determined for example by sieving according to DIN ISO 3310.

The refractory molding material and the optional molding material additives (if any) are referred to as molding material mixture. Examples of molding material additives include organic or mineral additives such as iron oxides, silicates, aluminates, hollow microspheres, sawdusts or starches as well as mixtures thereof. They can be added to the refractory molding material to avoid casting flaws.

The amount of molding material additives is not particularly limited and is usually at most about 10% by weight, preferably at most about 7% by weight, and especially preferred at most about 1% by weight, based on the molding material mixture.

The amount of the refractory molding material in the molding material mixture is not particularly limited. The refractory molding material preferably accounts for at least about 80% by weight, more preferred at least about 90% by weight, especially preferred at least about 93% by weight, and particularly preferred 99% by weight of the molding material mixture.

In a preferred embodiment, amorphous SiO₂ is used as a molding material additive.

### Binder

The binder is a multi-component system comprising at least
a) monomeric furfuryl alcohol and optionally a resin component comprising at least a furan resin, wherein about 60% by weight to 100% by weight of monomeric furfuryl alcohol, based on the sum of monomeric furfuryl alcohol and resin component, are present in the binder, and
b) a hardener component selected from methanesulfonic acid, benzenesulfonic acid, and mixtures thereof.

Within the framework of the present invention, all liquid components used in the method according to the present invention are considered components of the binder.

### Resin Component

Within the framework of the present invention, all polymeric and oligomeric components of the binder are referred to as resin component.

The binder can optionally comprise a resin component. If the resin component is present, the resin component comprises a furan resin. The furan resin is not particularly limited and can be any furan resin known in the art.

Furan resins are usually obtained from furan compounds, in particular from furfuryl alcohol and an aldehyde compound, in particular formaldehyde. Besides furfuryl alcohol, furfuryl alcohol derivatives such as 2,5-bis(hydroxymethyl)furan, methyl or ethyl ethers of 2,5-bis(hydroxymethyl)furan or 5-hydroxymethylfurfural can be used as comonomers.

Generally, compounds of the formula R-CHO are used as the aldehyde compound, wherein R is a hydrogen atom or a hydrocarbon group with preferably 1 to 8, especially preferred 1 to 3 carbon atoms. Examples include formaldehyde, acetaldehyde, propionaldehyde, and butyraldehyde. Furfurylaldehyde (furfural) and glyoxal can also be used. Mixtures of more than one aldehyde compound are possible as well. Formaldehyde or mixtures containing primarily formaldehyde (based on the molar amount of the aldehydes) are particularly preferred. Formaldehyde is most preferred.

The molar ratio of furan compound (in particular furfuryl alcohol) to aldehyde (in particular formaldehyde) is typically greater than or equal to about 0.5, preferably it is from about 1:0.2 to about 1:1.5, more preferred from about 1:0.2 to about 1:0.8, and especially preferred from about 1:0.3 to about 1:0.7.

In addition, one or more other compounds can be reacted when reacting an aldehyde compound and a furan compound, such as compounds containing nitrogen, for example urea, furfuryl alcohol derivatives and/or phenol compounds.

Optionally, the resin component can comprise a compound containing nitrogen to improve the properties of the resulting part, e.g. strength. They are not particularly limited. Suitable compounds containing nitrogen are for example urea derivatives such as urea itself, melamine or ethylene urea, or amines such as ammonia and triethylamine, amino alcohols such as monoethanolamine or 2-amino-2-methyl-1-propanol. Urea, triethylamine or monoethanolamine, in particular urea, are used in a particularly preferred embodiment.

The compound containing nitrogen can be made to react directly with the other reactants or with their pre-condensate, or in a preferred variation, added as an independent pre-condensate, in particular in the form of urea derivatives such as preferably urea itself, condensed with an aldehyde, preferably formaldehyde, and optionally condensed with preferably furfuryl alcohol or a furfuryl alcohol derivative.

The amount of the nitrogen-containing compound can be selected such that the total nitrogen content (N) of the resin component, determined according to Kjeldahl (according to DIN 16916-02-B2 or VDG specification P70), is at most about 5% by weight, preferably at most about 3.5% by weight, and especially preferred at most about 2% by weight, so that surface flaws due to the presence of nitrogen are reduced or avoided in the resulting casting.

Optionally, phenol compounds can be present in the resin component to improve the technical sand properties, for example strength. The phenol compounds are not particularly limited. However, suitable phenol compounds are characterized by one or more aromatic rings and at least one hydroxy substitution on these rings. In addition to phenol itself, examples include substituted phenols such as cresols or nonylphenol, 1,2-dihydroxybenzene (catechol), 1,3-dihydroxybenzene (resorcinol), cashew nutshell oil, i.e., a mixture of cardanol and cardol, or 1,4-dihydroxybenzene (hydroquinone) or phenolic compounds such as bisphenol A or mixtures thereof. Phenol is especially preferred as a phenolic compound.

The phenol compound can be made to react directly with the other reactants or with their pre-condensate. Moreover, reaction products of phenols and formaldehyde in the form of resol resins, which are produced under alkaline conditions, can be added to the resin component.

The total content of free phenol based on the binder is preferably at most about 1% by weight (determined by gas chromatography).

The total amount of furan compound (in particular furfuryl alcohol) and aldehyde compound (in particular formaldehyde) (both as monomer) is at least about 60% by weight, preferably at least about 70% by weight, and especially preferred at least about 80% by weight, based on all the reactants used.

The reaction can be carried out in the presence of an acid catalyst preferably with a pKₐ value at 25° C. of greater than or equal to 2.5, more preferred those with a pKₐ value of about 2.7 to about 6.0, and especially preferred with a pKₐ value of about 3.0 to about 5.0.

In the preparation of the furan resin, weak acids, mixtures thereof, as well as their salts preferably with a pKₐ value at 25° C. greater than or equal to 2.5, more preferred those with a pKₐ value of about 2.7 to about 6.0, and especially preferred with a pKₐ value of about 3.0 to about 5.0 are used as acid catalysts. They preferably include organic acids such as benzoic acid, lactic acid, adipic acid, citric acid or salicylic acid. Zinc acetate is mentioned as an example of a salt.

Suitable furan resins are for example described in WO 2004/7110719, WO 2018/224093, DE 20 2011 110 617 U1, as well as in DE 10 2014 002 679 A1, which are herewith incorporated by reference.

The furan resin can be present in the resin component in an amount of 50% by weight to about 100% by weight, preferably 60% by weight to about 99% by weight, and especially preferred 30% by weight to about 97% by weight.

In a preferred embodiment, the resin component can furthermore comprise a urea-formaldehyde resin.

The urea-formaldehyde resin can be present in the resin component in an amount of 0 to about 25% by weight, preferably about 1 to about 20% by weight, and especially preferred about 3 to about 15% by weight. The urea-formaldehyde resin is not particularly limited. The urea-formaldehyde resin can be obtained by reacting an aldehyde compound (in particular formaldehyde) with monomers containing nitrogen (in particular urea).

The molar ratio of urea and formaldehyde can be at most about 1, preferably it is from about 1:1 to about 1:5, more preferred about 1:1 to about 1:4, and especially preferred about 1:1.2 to about 1:3. Strong acids, mixtures thereof, as well as their salts, preferably with a pKₐ value at 25° C. of greater than or equal to about -2.5, more preferred those with a pKₐ value of about -2.5 to about 2.0, and especially preferred with a pKₐ value of about 0 to about 2.0 are used as acid catalysts for the reaction of urea and formaldehyde. They preferably include para-toluenesulfonic acid or salts of phosphoric acid such as sodium phosphate.

The urea-formaldehyde resin has a positive effect on the development of the strength of the shaped body produced by layer-by-layer production.

Furthermore, the resin component can comprise a phenol-formaldehyde resin, in particular a resol resin. The phenol-formaldehyde resin can be present in the resin component in an amount of 0% by weight to about 25% by weight, preferably 0% by weight to about 20% by weight, and especially preferred 0% by weight to about 15% by weight.

### Monomeric Furfuryl Alcohol

The binder comprises about 60% by weight to 100% by weight of monomeric furfuryl alcohol, based on the sum of resin component and monomeric furfuryl alcohol, i.e. if the sum of resin component, monomeric furfuryl alcohol, and optional components is considered 100 parts by weight, the amount of monomeric furfuryl alcohol accounts for about 60 parts by weight to 100 parts by weight. Preferably, the amount of monomeric furfuryl alcohol is about 60% by weight to about 99% by weight, more preferred about 60% by weight to about 98% by weight, and especially preferred about 70% by weight to about 98% by weight, based on the sum of the resin component, monomeric furfuryl alcohol, and optional components. The amount of monomeric furfuryl alcohol can for example be determined by means of gas chromatography (see VDG specification P70 “Bindemittelprüfung, Prüfung von flüssigen säurehärtbaren Furanharzen”, 3rd edition, April 1989).

It was found that binders comprising about 60% by weight to 100% by weight of monomeric furfuryl alcohol, based on the sum of resin component and monomeric furfuryl alcohol, result in shaped bodies exhibiting a higher strength than shaped bodies produced with a binder having a lower furfuryl alcohol content. However, this increase in strength leads to a significant increase in matter adhering to the part. It has been surprisingly found that only by using the hardener component b) according to the present invention, not only the desired increased strength but also a reduction in the resulting adherend matter can be achieved.

Monomeric furfuryl alcohol can be added to the binder as such. Alternatively, or in addition, a commercially available furan resin can be used which has a corresponding residual content of monomeric furfuryl alcohol.

### Hardener Component

The hardener component b) consists of methanesulfonic acid, benzenesulfonic acid, or mixtures thereof.

The amount of hardener component b) is preferably about 0.05% by weight to about 1.5% by weight, more preferred about 0.05% by weight to about 1.25% by weight, and especially preferred about 0.05% by weight to about 1% by weight, based on the amount of molding material mixture which is considered 100% by weight.

### Optional Components

The binder can comprise additional optional components such as phenol compounds, water, glycol, alcohol, solvents, plasticizers, curing moderators, surface modifiers or surfactants. The optional components can be applied together with component a), together with component b), together with component a) and component b), or separately from components a) and b).

### Phenolic Compounds

Optionally, phenolic compounds can be present to improve the technical sand properties, for example strength. The phenolic compounds are not particularly limited. However, suitable phenol compounds are characterized by one or more aromatic rings and at least one hydroxy substitution on these rings. In addition to phenol itself, examples include substituted phenols such as cresols or nonylphenol, 1,2-dihydroxybenzene (catechol), 1,3-dihydroxybenzene (resorcinol), cashew nutshell oil, i.e., a mixture of cardanol and cardol, or 1,4-dihydroxybenzene (hydroquinone) or phenolic compounds such as bisphenol A or mixtures thereof. Resorcinol is especially preferred as a phenolic compound. The phenolic compounds are preferably applied together with component a).

### Water

The binder can optionally comprise water for dilution.

The amount of water is not particularly limited; preferably, the amount of water is about 0.009% by weight to about 60% by weight, more preferred about 0.1% by weight to about 50% by weight, especially preferred about 0.5% by weight to about 45% by weight, and particularly preferred about 1% by weight to about 40% by weight, based on the binder.

The hardener component b) can optionally comprise water for dilution. Here, the amount of water is 10% by weight to 90% by weight, preferably 25% by weight to 75% by weight, more preferred 40% by weight to about 60% by weight, based on the hardener component b) which is considered 100%.

The amount of water can be determined by means of Karl Fischer titration according to DIN 51777.

### Glycol

Furthermore, the binder can comprise a glycol to improve the technical sand properties of the resulting three-dimensional shaped bodies, in particular to improve their elasticity and reduce brittleness. The glycol is not particularly limited; any glycol can be used - polymeric glycols such as polyethylene glycols are conceivable as well. Ethylene glycol, butyl diglycol and combinations thereof are preferred, and ethylene glycol is particularly preferred. The amount of glycol is not particularly limited; preferably, glycol is present in an amount of about 0.5% by weight to about 10% by weight, more preferred about 1% by weight to about 5% by weight, based on the amount of hardener component b) which is considered 100% by weight. Preferably, glycol is introduced together with component b).

### Alcohol

The binder can optionally also comprise a C₁₋₄ alcohol different from glycol (preferably ethanol) or mixtures thereof. The alcohol serves to optimize the technical sand properties. The amount of alcohol is not particularly limited; preferably, the alcohol is present in an amount of about 1% by weight to about 25% by weight, more preferred about 2% by weight to about 10% by weight, based on the amount of binder.

### Solvent

In one embodiment, the binder can additionally comprise further solvents, in particular organic solvents comprising 1 to 25 carbon atoms such as alcohols like ethanol, propanol, 5-hydroxy-1,3-dioxane, 4-hydroxymethyl-1,3-dioxolane or tetrahydrofurfuryl alcohol, oxetanes such as trimethylolpropane oxetane, ketones such as acetone, or esters such as triacetine and propylene carbonate. The amount of further solvents is not particularly limited; preferably, the other solvents are present in an amount of about 1% by weight to about 25% by weight, more preferred about 2% by weight to about 10% by weight, based on the amount of binder.

### Plasticizers and Curing Moderators

Common plasticizers or curing moderators can be contained in the binder to adjust the strength and elasticity of the shaped body. They include for instance diols or polyols with 2 to 12 carbon atoms, fatty acids, silicones or phthalates. Fatty acids like oleic acid are especially preferred.

The plasticizers or curing moderators are present in common amounts which can range from for example 0% by weight to about 25% by weight, preferably 0% by weight to about 20% by weight, and more preferred about 0.2% by weight to about 15% by weight, based on the resin component.

### Surface Modifiers

Surface modifiers for adjusting the surface tension and for improving the technical sand properties can also be added to the binder. It is known from EP 1 137 500 A1 to use silanes as surface modifiers. Suitable silanes include, for example, amino silanes, epoxy silanes, mercapto silanes, hydroxy silanes, and ureido silanes such as γ-hydroxypropyl trimethoxysilane, γ-aminopropyl trimethoxysilane, 3-ureidopropyl triethoxysilane, γ-mercaptopropyl trimethoxysilane, γ-glycidoxypropyl trimethoxysilane, β-(3,4-epoxy-cyclohexyl)-trimethoxysilane and N-beta-(aminoethyl)-γ-aminopropyl trimethoxysilane or polysiloxanes.

The amount of surface modifiers is within the common range and can be for instance from 0% by weight to about 5% by weight, preferably about 0.01% by weight to about 2.00% by weight, and more preferred about 0.05% by weight to about 1.00% by weight, based on the resin component.

### Surfactants

In order to decrease surface tension, surfactants such as cationic, anionic or non-ionic surfactants can be used. Examples include carboxylates, sulfonates or sulfates like sodium2-ethylhexyl sulfate as anionic surfactants, quaternary ammonium compounds like esterquats as cationic surfactants, or alcohols, ethers or ethoxylates like polyalkylene glycol ether as nonionic surfactants. Modified siloxanes such as 3-(polyoxyethylene)propylheptamethyl trisiloxane, which have a hydrophobic and a hydrophilic part, are conceivable as well. They are preferably used together with the resin component when it is selectively applied in order to facilitate application.

It was found to be especially advantageous when the hardener component b) is used in the form of a mixture together with water and optionally glycol (in particular ethylene glycol) in the method according to the present invention.

The hardener component b) is present in this mixture in an amount of 10% by weight to about 90% by weight, preferably about 25% by weight to about 75% by weight, more preferred about 30% by weight to about 70% by weight, and especially preferred about 40% by weight to about 60% by weight.

Glycol is present in this mixture in an amount of about 0% by weight to about 15% by weight, preferably about 2% by weight to about 10% by weight, and more preferred about 4% by weight to about 8% by weight.

Water is present in this mixture in an amount of about 10% by weight to 90% by weight, preferably 25% by weight to 75% by weight, more preferred 40% by weight to 60% by weight, based on the hardener component b) which is considered 100%.

### Method for the Layer-by-Layer Production of a Cured Three-Dimensional Shaped Body

The method for the layer-by-layer production of a cured three-dimensional shaped body comprises at least:
(i) providing the binder,
(ii) providing a layer of a refractory molding material to provide a molding material layer,
(iii) selectively applying a component a) or b) of the binder separately from the refractory molding material to at least a part of the molding material layer,
(iv) applying the other component of the binder separately from the component mentioned in step (iii), wherein step (iv) can be carried out before or after step (iii) or step (iv) can be combined with step (ii), and
(v) optionally repeating steps (ii), (iii) and (iv) once or several times.

### Step (ii): Providing a Layer of a Refractory Molding Material to Provide a Molding Material Layer

In the method according to the present invention, first a layer of the refractory molding material and optionally molding material additives is applied. The thickness of the layer can e.g. be about 0.03 mm to about 3 mm, preferably about 0.03 to about 1.5 mm. In this step, one or more binder components can be applied as well, if desired, for example by mixing it/them with the refractory molding material before the layer of the refractory molding material is provided (combination of step (iv) and step (ii)).

### Step (iii): Selectively Applying a Component A) or B) of the Binder Separately From the Refractory Molding Material to at Least a Part of the Molding Material Layer

### Step (iv): Applying the Other Component of the Binder Separately From the Component Mentioned in Step (iii)

The term “applying” means bringing together two components. This can be done non-selectively or selectively.

During non-selective application, one component can be applied over the surface (for example onto the molding material layer). Alternatively, a component can be mixed with another component (for example with the refractory molding material) by means of a mixing apparatus or manually.

During selective application, a component is applied to certain areas of the other component. During selective application, the component is preferably only applied to certain sections of the other component. Selective application can for example be carried out by means of a printhead or a comparable application method. In one embodiment, the component to be applied can be applied by means of a mask. The mask is a sheet with areas that are impermeable for the component to be applied and areas (e.g. apertures) through which the component to be applied can pass and come into contact with certain areas of the other component. Such methods are for example screen printing or stencil printing.

In an especially preferred embodiment, the selective application is carried out by means of a printhead. Such a process is for example 3D printing which is also sometimes referred to as “binder jetting”. The component to be applied is applied by means of the printhead via jet printing. 3D printing is an additive manufacturing process wherein a powdery material is adhered to a binder at predetermined areas in order to obtain the desired shaped body. Such processes are standardized e.g. in the VDI Guideline 3405.

In step (iii), either component a) or component b) of the binder is applied to the part of the molding material layer to be cured. When components a) and b) of the binder are mixed and applied together, premature curing reactions can take place in the applicator (e.g. in the printhead). This can e.g. cause the applicator (e.g. the printhead) to become clogged which leads to decreased productivity. For this reason, component a) is applied separately from the hardener component b). The optional components can either be added to component a) and/or to the hardener component b), or be applied separately from those components. In order to reduce the number of steps, it is preferred that the optional components be added to component a) and/or to the hardener component b).

In a preferred embodiment, component a) is mixed with the refractory molding material and the molding material additives (if any) and applied together with them as molding material layer. Then the hardener component b) is selectively applied to at least a part of the thus activated molding material layer.

In another especially preferred embodiment, the hardener component b) is mixed with the refractory molding material and the molding material additives (if any) and applied together with them as molding material layer. Then component a) is selectively applied to at least a part of the thus activated molding material layer.

In yet another preferred embodiment, the refractory molding material and the molding material additives (if any) are mixed and provided as molding material layer. Then component a) and the hardener component b) are applied onto the molding material layer via two separate printheads. In this connection, it was found to be advantageous if one of the components was applied over the surface (e.g. the entire surface area of the molding4 material layer) and the other component was selectively applied to the portion of the molding material layer to be cured.

The mixture of refractory molding material and molding material additives (if any) as well as hardener component b) or component a) can e.g. be applied at temperatures of about 10° C. to about 45° C.

The selective application of a component is known in the art and can be carried out using common processes. The temperature (in 3D printing the temperature of the printhead) is not limited to room temperature but can be about 20° C. to about 80° C., in particular at about 20° C. to about 40° C. Thus, components with a higher viscosity can easily be applied as well.

When the binder component a) or the hardener component b) are selectively applied either alone or with other components, the viscosity should be adjusted accordingly to the application process in question. For application by means of a printhead, the viscosity (Brookfield, 25° C., spindle 21, DIN EN ISO 2555) should be about 2 mPas to about 70 mPas, preferably about 5 mPas to about 60 mPas, and more preferred about 5 mPas to about 50 mPas.

When the binder component a) or the hardener component b) are selectively applied either alone or with other components, the surface tension should be adjusted accordingly to the application process in question. For application by means of a printhead, the surface tension should be about 10 mN/m to about 70 mN/m, preferably about 15 mN/m to about 60 mN/m, more preferred about 15 mN/m to about 55 mN/m, and especially preferred about 20 mN/m to about 50 mN/m, determined using the Wilhelmy plate method with a Kruss K100 force tensiometer measured at 20° C.

### Step (v): Optionally Repeating Steps (ii), (iii) and (iv) Once or Several Times

In step (v), the steps (ii), (iii) and (iv) can be repeated one or more time. Preferably the steps are repeated one or more times.

By repeating steps (ii), (iii) and (iv), even complex shaped bodies can be constructed step by step. The number of repetitions is predetermined by the size of the shaped body and the thickness of the individual layers and can sometimes be higher than one thousand.

The number of repetitions is not particularly limited and can range, for instance, from about 2 to about 10 000, preferably about 2 to about 5 000, more preferably about 5 to about 2 500 and even more preferably about 10 to about 1 000.

Optionally, additional process steps can follow the claimed process. For instance, after the layer-by-layer production has been completed, curing can take place. This is not particularly limited; all known curing processes can be used. Preferably, curing is carried out in an oven or by means of a microwave.

If necessary, uncured adhesions of starting material can be removed from the at least partially cured shaped body.

As a matter of course, any and all combinations of the preferred embodiments mentioned herein are encompassed by the present invention.

According to a first preferred alternative, the method according to the present invention comprises at least the following steps:

ia) Preparing a mixture of the refractory molding material and the hardener component b).

For this step, the refractory molding material is preferably used in an amount of at least about 80% by weight, more preferred at least about 90% by weight, and especially preferred at least about 95% by weight, based on the molding material.

The amount of hardener component b) is preferably about 0.05% by weight to about 1.5% by weight, more preferred about 0.05% by weight to about 1.25% by weight, and especially preferred about 0.05% by weight to about 1% by weight, based on the amount of mold material mixture which is considered 100% by weight.

ib) Providing a layer of the mixture of the refractory molding material and the hardener component b).

ic) Selectively applying component a) to at least a part of the layer.

Component a) is applied to the areas of the spread-out mixture of refractory molding material and hardener component b) to be cured.

The amount of component a) can be from about 0.1% by weight to about 5% by weight, preferably about 0.3% by weight to about 4% by weight, and more preferred about 0.5% by weight to about 3% by weight, based on the mold material mixture.

id) If desired, step ib) and ic) can be repeated once or several times.

According to a second preferred alternative, the method according to the present invention comprises at least the following steps:

iia) Preparing a mixture of refractory molding material and component a).

For this step, the refractory molding material is preferably used in an amount of at least about 80% by weight, more preferred at least about 90% by weight, and especially preferred at least about 95% by weight, based on the mold material mixture. In one embodiment, the amount of refractory molding material can be 100% by weight, based on the mold material mixture.

Component a) can be used in an amount of about 0.1% by weight to about 5.3% by weight, preferably 0.3% by weight to about 4.3% by weight, and more preferred about 0.5% by weight to about 3.1% by weight, of component a) based on the refractory molding material, and about 0.1% by weight to about 5% by weight, preferably about 0.3% by weight to about 4% by weight, and more preferred about 0.5% by weight to about 3% by weight, based on the mold material mixture.

iib) Providing a layer of the mixture of refractory molding material and component a).

iic) Selectively applying the hardener component b) to at least a part of the layer.

The hardener component b) is applied to the areas of the spread-out mixture of refractory molding material and component a) to be cured.

The amount of hardener component b) is preferably about 0.05% by weight to about 1.5% by weight, more preferred about 0.05% by weight to about 1.25% by weight, and especially preferred about 0.05% by weight to about 1% by weight, based on the amount of molding material mixture which is considered 100% by weight.

iid) If desired, step iib) and iic) can be repeated once or several times.

According to a third preferred alternative, the method according to the present invention comprises at least the following steps:

iiia) Providing a layer of the refractory molding material.

iiib1) Applying the hardener component b) over the surface (e.g. the complete surface of the refractory molding material) of the layer by means of a first applicator (e.g. by means of a first printhead).

iiib2) Selectively applying component a) by means of a second applicator (e.g. by means of a second printhead) to at least a part of the layer onto which the hardener component b) was applied.

iiic) If desired, steps iiia), iiib1), and iiib2) can be repeated once or several times.

According to a fourth preferred alternative, the method according to the present invention comprises at least the following steps:

iva) Providing a layer of the refractory molding material.

ivb1) Applying component a) over the surface (e.g. the complete surface of the refractory molding material) of the layer by means of a first applicator (e.g. by means of a first printhead).

ivb2) Selectively applying the hardener component b) by means of a second applicator (e.g. by means of a second printhead) to at least a part of the layer onto which component a) was applied.

ivc) If desired, steps iva), ivb1) and ivb2) can be repeated once or several times.

The explanations regarding the process steps and the amounts of the components made in connection with the first and second alternatives analogously apply to the third and fourth alternatives as well.

It is self-evident that the explanations which were given with respect to the steps of the method according to the invention apply to the first, second, third and fourth alternatives, respectively.

All the optional components discussed within the framework of the present invention can of course optionally be used in alternatives one through four.

The term “mold material mixture” refers to the overall composition comprising all the components immediately prior to curing but only to the extent that at least component a), hardener component b) and the molding material are present in the corresponding volume portion so that the volume portion can cure. Volume portions in the job box that do not contain the hardener component b) or component a) are not attributed to the mold material mixture but are instead identified as a mixture consisting of a refractory molding material and component a), or a mixture consisting of a refractory molding material and hardener component b).

### EXAMPLES

The invention will be explained in more detail by means of examples, however, without being limited thereto.

Unless otherwise indicated, all ratios and percentages are based on weight.

### Example 1: Examination to Reduce Adhesions

0.3% by weight of hardener were added to each of two molding material mixtures consisting of Sand GS 19 (mean grain diameter 0.19 mm) (molding material mixture 1) or Sand GS 19 with additional 0.2% by weight of a powdery additive (amorphous SiO₂, tradename INOTEC Promotor EP 4500, from the company ASK Chemicals GmbH) (molding material mixture 2), and the mixtures were homogenized in a paddle mixer in order to evaluate the tendency of unbonded sand to adhere to bonded sections in the layer-by-layer production of three-dimensional bodies.

Hardener 1 is a mixture of 65% para-toluenesulfonic acid and 35% water.

Hardener 2 is a mixture of 35% para-toluenesulfonic acid, 35% xylenesulfonic acid, and 30% water.

Hardener 3 is a mixture of 50% methanesulfonic acid, 45% water, and 5% monoethylene glycol (MEG).

Hardener 4 is a mixture of 65% para-toluenesulfonic acid, 35% water, and 5% monoethylene glycol (MEG).

The test pieces were produced on a commercial printing system (VX 200 from the company Voxeljet AG). A commercially available furan resin (ASKURAN 3D 120 from the company ASK Chemicals GmbH), which comprises 87% by weight furfuryl alcohol, was used as component a). The amount of component a) was set to 2 parts by weight, based on 100 parts by weight of molding material mixture, in all tests.

Test pieces were printed to determine their bending strength (dimensions 18.4 mm ×18.4 mm × 100 mm) and tested on a universal testing machine (Zwick Z010).

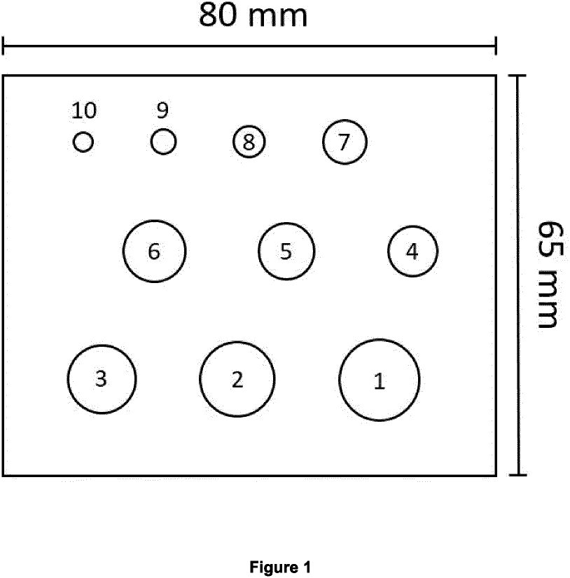

A specific specimen geometry was created to quantify the adhesions occurring during the production process. The geometry and the corresponding dimensions are shown in FIG. 1. The dimensions of the apertures shown in FIG. 1 are listed in Table 1.

TABLE 1

Dimensions of the apertures in FIG. 1

| No. of the aperture | Diameter of the aperture [mm] |
|---|---|
| 1 | 13 |
| 2 | 12 |
| 3 | 11 |
| 4 | 10 |
| 5 | 9 |
| 6 | 8 |
| 7 | 7 |
| 8 | 5 |
| 9 | 4 |
| 10 | 3 |

After the production of the test pieces, the adhering sand was removed completely with a spatula from the top and bottom sides and the outer edges of the piece so that only the sand in the apertures of the test piece geometry remained. This was done with as little jolling as possible so as to not also remove the sand in the apertures as well. Then the test piece was placed onto a sieve and put on a vibration plate (Multiserv LUZ-2e). This vibration plate was induced for a time period of 5 seconds with an amplitude of 0.01, and this process was repeated twelve times. Thus, the total vibration time was 60 seconds. Subsequently, it was visually evaluated how many and which apertures were opened due to vibration and thus freed of sand adhesions. Since both the production of the test pieces and the induced vibration were kept constant, this test allows an evaluation of the sand adhesions caused by the materials system used therein. The results of the tests are shown in Table 2.

TABLE 2

Strength and evaluation of the sand adhesions for different mold material mixtures and hardeners during printing of 2% ASKURAN 3D 120 on the VX 200 printing machine

| | Molding material mixture | Hardener | Bending strength [N/cm²] | Free apertures after vibration (number acc. to FIG. 1 ) |
|---|---|---|---|---|
| Comp. Example 1 | Molding material mix. 1 | Hardener 1 | 322 | 1 to 4 |
| Comp. Example 2 | Molding material mix. 2 | Hardener 1 | 350 | 1 to 2 |
| Comp. Example 3 | Molding material mix. 1 | Hardener 2 | 295 | 1 to 3 |
| Comp. Example 4 | Molding material mix. 2 | Hardener 2 | 400 | 1 to 4 |
| Comp. Example 5 | Molding material mix. 2 | Hardener 4 | 402 | 1 to 3 |
| Example 1 | Molding material mix. 1 | Hardener 3 | 338 | 1 to 8 |
| Example 2 | Molding material mix. 2 | Hardener 3 | 370 | 1 to 8 |

The tests show that the use of the hardener component used according to the present invention leads to a significantly reduced sand adhesion in the resulting test pieces (see Table 2). At the same time, the strength of the test pieces is not affected. Thus, the hardener component used in the method of the present invention allows a significant reduction in adhesions occurring during production as well as in the required post-processing, without negatively impacting the strength of the resulting rest pieces.

### Example 2

Based on the process discussed in Example 1, test pieces with different acids as hardener component were produced using the molding material mixture 2 from Example 1 as well as the processing according to Example 1.

| No. | Hardener | Bending strength [N/cm²] | Free apertures after vibration |
|---|---|---|---|
| C-1 | p-Toluenesulfonic acid (65% in water) | 386 | 1 to 3 |
| C-2 | Xylenesulfonic acid (55% in water) | 407 | 1 to 3 |
| C-3 | Sulfuric acid (50% in water) | 185 | 1 to 9 |
| 4 | 50% Methanesulfonic acid + 50% water | 336 | 1 to 8 |
| 5 | Benzenesulfonic acid + methanesulfonic acid in a ratio of 1:1 (70% in water) | 366 | 1 to 7 |

Test piece 4 according to the present invention showed excellent strength and very low sand adhesion.

Test piece 5 according to the present invention with benzenesulfonic acid and methanesulfonic acid showed a slightly improved strength but also slightly higher sand adhesion than test piece 4. However, it also showed good results.

Comparative test pieces C-1 and C-2 showed significant sand adhesion which required extensive post-processing of the test pieces.

Comparative test piece C-3 showed low strength which limited its practical use.

1. A method for the layer-by-layer production of a cured three-dimensional shaped body, wherein the method comprises at least:
(i) providing a binder comprising at least the components:
a) monomeric furfuryl alcohol and optionally a resin component comprising at least a furan resin, wherein about 60% by weight to 100% by weight of monomeric furfuryl alcohol, based on the sum of monomeric furfuryl alcohol and resin component are present in the binder, and
b) a hardener component selected from methanesulfonic acid, benzenesulfonic acid, and mixtures thereof,
(ii) providing a layer of a refractory molding material to provide a molding material layer,
(iii) selectively applying a component a) or b) of the binder separately from the refractory molding material to at least a part of the molding material layer,
(iv) applying the other component of the binder separately from the component mentioned in step (iii), wherein step (iv) can be carried out before or after step (iii), or step (iv) can be combined with step (ii), and
(v) optionally repeating steps (ii), (iii), and (iv) once or several times.

2. The method according to claim 1, wherein the method comprises at least:
A) preparing a mixture of the refractory molding material and the hardener component b),
B) providing a layer of the mixture of the refractory molding material and the hardener component b),
C) selectively applying component a) of the monomeric furfuryl alcohol and the optional resin component to at least a part of the layer, and
D) optionally repeating steps B) and C) once or several times.

3. The method according to claim 1, wherein the method comprises at least:
A) preparing a mixture of the refractory molding material and the component a) of monomeric furfuryl alcohol and the optional resin component,
B) providing a layer of the mixture of the refractory molding material and component a),
C) selectively applying the hardener component b) to at least a part of the layer, and
D) optionally repeating steps B) and C) once or several times.

4. The method according to claim 1, wherein the method comprises at least:
A) providing a layer of the refractory molding material,
B) applying component a) of the monomeric furfuryl alcohol and the optional resin component over the surface of the layer,
C) selectively applying the hardener component b) to at least a part of the layer onto which component a) was applied, and
D) optionally repeating steps A), B), and C) once or several times.

5. The method according to claim 1, wherein the method comprises at least:
A) providing a layer of the refractory molding material,
B) applying the hardener component b) over the surface of the layer,
C) selectively applying component a) of the monomeric furfuryl alcohol and the optional resin component to at least a part of the layer onto which the hardener component b) was applied, and
D) optionally repeating steps A), B), and C) once or several times.

6. The method according to claim 1, wherein the binder comprises about 60% by weight to about 98% by weight of monomeric furfuryl alcohol, based on the sum of resin component and monomeric furfuryl alcohol.

7. The method according to claim 1, wherein the selective application is carried out by means of a printhead.

8. The method according to claim 7, wherein the selective application is carried out by means of jet printing.

9. A shaped body obtainable by the method according to claim 1.

10. A method comprising:
providing the shaped body according to claim 9, wherein the shaped body is a casting core or a mold for metal casting, and
conducting metal casting, in particular iron, steel, copper, or aluminum casting.
